(19) United States
(12) Patent Application Publication
(10) Pub. No.: US 2014/0237487 A1
(43) Pub. Date: Aug. 21, 2014

(54) COMPLEX EVENT PROCESSING FOR DYNAMIC DATA

(71) Applicant: University of Southern California, Los Angeles, CA (US)

(72) Inventors: Viktor K. Prasanna, Los Angeles, CA (US); Om Prasad Patri, Los Angeles, CA (US); Vikrambhai S. Sorathia, Gandhinagar (IN); Anand V. Panangadan, Los Angeles, CA (US)

(73) Assignee: UNIVERSITY OF SOUTHERN CALIFORNIA, Los Angeles, CA (US)

(21) Appl. No.: 14/177,099

(22) Filed: Feb. 10, 2014

Related U.S. Application Data
(60) Provisional application No. 61/765,577, filed on Feb. 15, 2013.

(51) Int. Cl. G06F 9/54

(52) U.S. Cl. CPC G06F 9/542
USPC 719/318

(57) ABSTRACT

A complex event processing system and method of operation are disclosed. The system includes, in one example, a monitor configured to detect, from measurements received from one or more data streams, observations relating to the measurements, and interpretations of the observations, a plurality, an occurrence of an event, and a state transition engine configured to receive the event and, based at least in part on the event, determine a current state of a particular entity of a dynamic system based on a state model as well as a next state of the particular entity to which the state model should transition, wherein the particular entity of the dynamic system is associated with the event. The system also includes an action determination component configured to determine an action to be taken based on the current state and the next state, a role determination component configured to determine a role associated with the action to be taken, and a notification component configured to generate one or more notifications to entities associated with the role, the one or more notifications including the action to be taken.

### CROSS-REFERENCE TO RELATED APPLICATIONS

The present application claims priority from U.S. Provisional Application No. 61/765,577, filed on Feb. 15, 2013, (Chevron Docket No. T-9370P) the disclosure of which is hereby incorporated by reference in its entirety.

### TECHNICAL FIELD

The present application relates generally to complex event processing systems, and in particular relates to improvements to complex event processing to accommodate dynamic data.

### BACKGROUND

The availability of massive amounts of data from diverse sources such as sensor streams, transactional systems, social networks, web activity and history logs has necessitated the use of big data technologies for mining and correlating useful information. Often, this information is used for time-critical and strategic business applications by enterprises (such as gathering business intelligence) and thus, loses its value if the integrated results cannot be utilized in near-real time. Big data is typically characterized by high volume, velocity and variety in data.

Stream processing approaches and event-based systems which incorporate complex event processing (CEP), have emerged as a widely accepted solution for dealing with data on the move in several application areas (such as finance, health care, transportation), especially those requiring high throughput and low latency. CEP systems perform continuous queries against the incoming data stream for detecting complex events. Based upon the detection of events, these systems typically perform certain actions according to predefined rules. Semantic complex event processing (SCEP) systems which enable CEP technologies to harvest the power of a knowledge base have been proved to improve interoperability and expressivity of CEP systems.

However, current CEP systems are not without shortcomings. Current CEP systems typically assume that the input data or event stream is obtained from similar data sources. They also consider that the data structure and schema does not change frequently. This assumption is not true in several real world scenarios. For example in the case of a modern oil field including various heterogeneous and dynamic data sources with complex interdependencies, such a system would be constantly changing as conditions change. Furthermore, current CEP systems are limited to detecting and notifying of an existence of an event. In real-world scenarios, multiple complications may arise following a simple event detection and notification, which may lead to the action not being completed in the scheduled time. Additionally, existing CEP systems typically treat every change in input data as an event that requires handling, rather than defining events in a way that would limit their definition to only relevant changes in data. Existing CEP systems do not have convenient ways to handle such issues.

For these and other reasons, improvements in the area of CEP systems are desirable.

### SUMMARY

In accordance with the following disclosure, the above and other issues may be addressed by the following:

In a first aspect, a complex event processing system includes a monitor configured to detect, from measurements received from one or more data streams, observations relating to the measurements, and interpretations of the observations, an occurrence of an event. The system also includes a state transition engine configured to receive the event and, based at least in part on the event, determine a current state of a particular entity of a dynamic system based on a state model as well as a next state of the particular entity to which the state model should transition. The particular entity of the dynamic system is associated with the event. The system further includes an action determination component configured to determine an action to be taken based on the current state and the next state, a role determination component configured to determine a role associated with the action to be taken, and a notification component configured to generate one or more notifications to entities associated with the role, the one or more notifications including the action to be taken.

In a second aspect, a method of processing complex events is disclosed. The method includes receiving a plurality of data streams from a dynamic system at a complex event processing system, and defining measurements based on data in the data streams, and observations associated with the measurements. The method also includes detecting an occurrence of an event based on interpretation of the observations. The method includes, upon occurrence of the event, determining a current state of a state model. If the current state is not a goal state, the method includes determining a next state to which the state model should transition. The method also includes, based on the current state and the next state, determining an action, a role, and a notification to be generated, and sending the notification and action to an entity assigned the role.

In a third aspect, a computer-readable storage medium having computer-executable instructions stored thereon is disclosed that, when executed by a computing system, performs a method of processing complex events in a dynamic system. The method includes receiving a plurality of data streams from a dynamic system at a complex event processing system, and defining measurements based on data in the data streams, and observations associated with the measurements. The method also includes detecting an occurrence of an event based on interpretation of the observations. The method includes, upon occurrence of the event, determining a current state of a state model. If the current state is not a goal state, the method includes determining a next state to which the state model should transition. The method also includes, based on the current state and the next state, determining an action, a role, and a notification to be generated, and sending the notification and action to an entity assigned the role.

### BRIEF DESCRIPTION OF THE DRAWINGS

FIG. 1 illustrates an example data arrangement useable in connection with an oil field, in an example application of the complex event processing system of the present disclosure;

FIG. 2 is a schematic block diagram of a computing system used to implement a complex event processing system, according to an example embodiment;

FIG. 3 is a flowchart of a process performed by a complex event processing system to detect and address events, according to an example embodiment;

FIGS. 4A-4B illustrate a flowchart of a process performed by a complex event processing system to detect and address events, according to a further example embodiment;

FIG. 5 is an example illustration of a data sharing arrangement for collecting knowledge used in the complex event processing system to detect and build a set of event profiles, according to an example embodiment;

FIG. 6 is an example definition of a basic temperature event profile occurring in a well, capable of being defined in the complex event processing system described herein;

FIG. 7 is an example definition of a complex temperature change event profile occurring in a well, capable of being defined in the complex event processing system described herein;

FIG. 8 is an example definition of a complex pump failure event profile occurring in a well, capable of being defined in the complex event processing system described herein;

FIG. 9 is an example definition of a complex production loss event profile, capable of being defined in the complex event processing system described herein;

FIG. 10 is an example state transition diagram for a well, capable of being defined in and applied by the complex event processing system described herein;

FIG. 11 is a flowchart illustrating an example event escalation process useable in connection with the process performed by the complex event processing system of FIG. 3, to detect and address events;

FIG. 12 illustrates a general-purpose process-oriented event model (PoEM) useable to implement event definitions according to a possible aspect of the present disclosure;

FIG. 13 illustrates an example of a process-oriented event model useable to detect a high pressure event in an oil field pump;

FIG. 14 illustrates an example of a process-oriented event model useable to generate a collision warning in an automotive application; And

FIG. 15 illustrates an example of a process-oriented event model useable to detect or predict ocean piracy events.

### DETAILED DESCRIPTION

As briefly described above, embodiments of the present invention are directed to a complex event processing system that is configured for use with dynamic data, and which is configured to, based on specific events or event types, define one or more responses or response types, defined as a combination of an action, role, and notification. In some embodiments, the present disclosure includes provision for escalation of issues, and in particular escalation of issues to define new actions, roles, and notifications, or otherwise acknowledge lack of reaction to an event, if no response has been taken within a predefined period of time after an event has been detected. The complex event processing system accomplishes this through, among other features, a specific definition of events and event profiles to ensure that events are defined that implicate a required action by an entity within a dynamic system being observed. Based on these definitions and data management techniques, static and dynamic systems can be monitored and events processed therein.

In the various embodiments described herein, a process-oriented event model is described in which a semantic framework can be used to both represent events and to encode rules used to detect events from sensor data. Additionally, definitions of the process for responding to such events are provided as well. By using the process-oriented event model, various events in a large-scale data model can be detected without determining that a triggering event has occurred each time a state of an observed system changes, due to the narrower definition of an event as described herein. For example, events may be detected from one or more data streams using pre-defined event profiles. The pre-defined event profiles may be determined from interpretations and simple events. The pre-defined event profiles suggest what needs to be queried to determine the occurrence of an event. This narrower definition of an event may therefore filter out many items from being processed and may reduce computational load. Furthermore, in some embodiments, events can, over time, be escalated to appropriate parties based on actions defined to be required to return that system to a goal state from a current state. Event escalation may be based on semantics web concepts. Additionally, in some cases event notifications may be filtered even though an event is detected through multiple mechanisms to avoid repeated notifications regarding the same event or root cause of related events. In short, the process-oriented event model may provide an end-to-end methodology (e.g., semantic template) that automatically detects events (e.g., in real-time from sensor data) and automatically makes decisions to respond to the events.

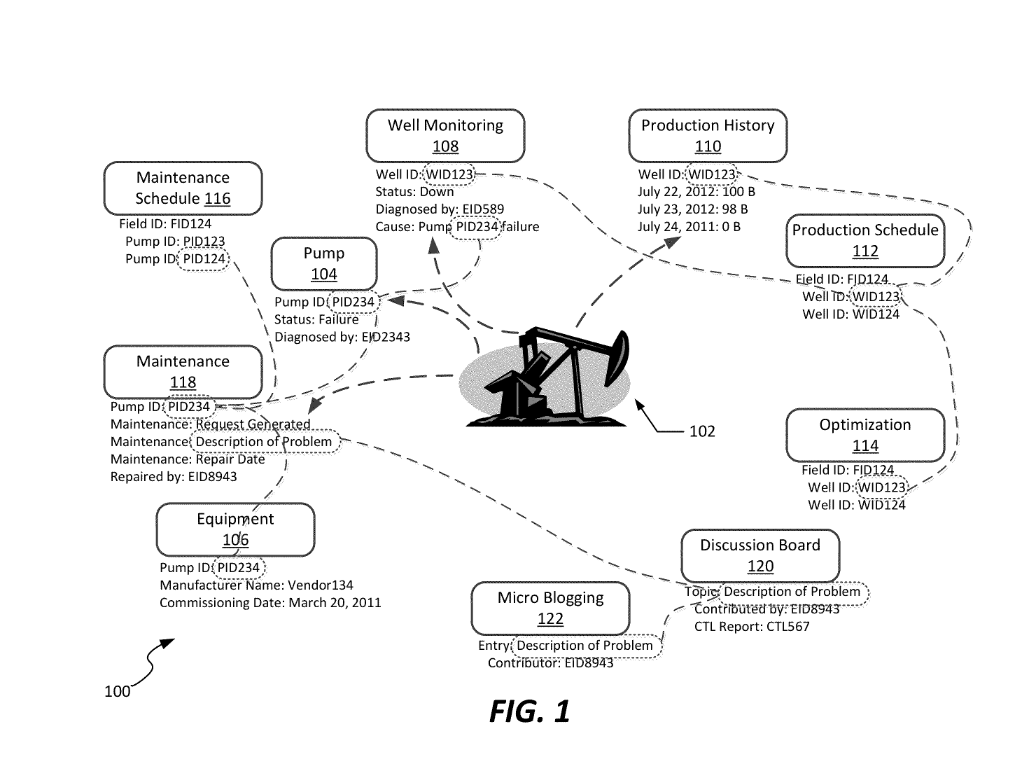

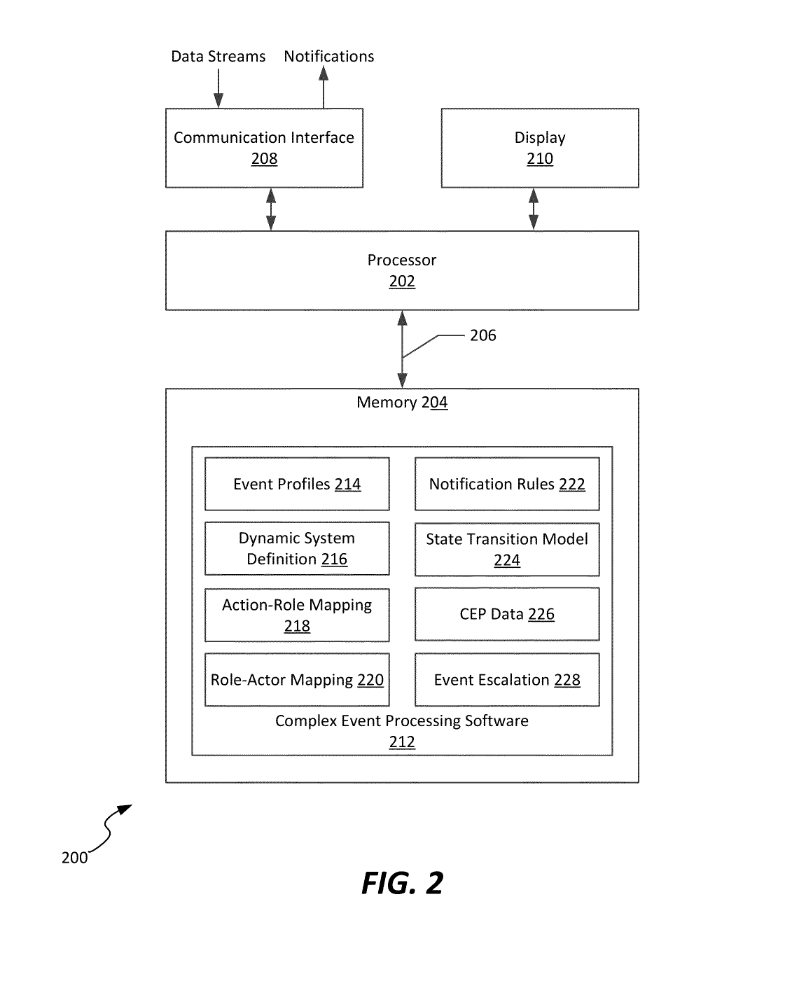

Now referring to FIG. 1, an example oil field data arrangement 100 is illustrated. The data arrangement 100 represents one of a wide variety of types of dynamic systems under observation by a complex event processing system that can be used. In accordance with the following disclosure, the data arrangement 100 provides for continuously updated data associated with a variety of physical and computed systems and subsystems, and which are provided as data streams to a computing system for monitoring by complex event processing software, as illustrated in FIG. 2.

In the embodiment shown, the oil field data arrangement 100 is associated with an oil field 102, and includes a variety of types of data stored separately and associated with different actors (or roles), but having functional interdependencies that are reflected in the types of events that may occur in the dynamic system from which data is received. For example, in the embodiment shown, the oil field 102 can include a variety of pump, well, tubing, control system, and other equipment. Each component that is to be tracked, and data associated with that component, can be tracked in separate tables defining entities and associated statuses. In the embodiment shown, a pump used in an oil field can be associated with a well, which may have multiple such pumps associated therewith. Additionally, there may be multiple such wells in an oil field 102. In the embodiment shown, a number of tracked elements are shown, which are included in data streams provided to a complex event processing system. These include data streams from a pump 104, equipment 106, well monitoring system 108, a production history 110, a production schedule 112, and an optimization system 114. It can also include, in some embodiments, a maintenance schedule 116, maintenance data 118, and a discussion board 120 and micro blogging system 122.

The pump 104 can track a pump identifier (shown as PID234) and pump status, as well as notes relating to the pump status such as the identification of the entity (e.g., a person or thing) that diagnosed the status of the pump. The equipment 106 corresponds to an inventory of all types of equipment, and can include, for each pump, a pump identifier, as well as a name of the manufacturer of that pump and its commissioning date. The well monitoring system 108 includes a well identifier (shown as WID123), as well as a well status, identifier of the individual or other entity diagnosing the status and cause of the well's current status.

The production history 110 includes a listing of wells and associated output on a periodic (e.g., daily, hourly, etc.) basis, while the production schedule 112 defines an identifier for the oil field 102, as well as the various wells that are being monitored. The optimization system 114 tracks the field and associated wells as well.

In the embodiment shown, a maintenance schedule 116 includes a field identifier and various pump identifiers, and a maintenance data record 118 includes specific maintenance tasks requested for particular pumps, including the pump identifier, request, description of a problem, a repair date, and a repairperson involved. A micro blogging system 122 allows contributors to enter problems observed at well sites, and a discussion board 120 publishes those descriptions, and assigns them to CTL (“close the loop”) reports useable to track issues in well sites.

It is noted that, in the overall system 100 of FIG. 1, there are a number of interdependencies among the various data elements forming portions of data streams to a complex event processing system. For example, the pump identifier in the equipment 106 and pump 104 are the same, and are used to refer to the pump in the maintenance schedule 116 and maintenance data record 118. A description of an issue entered in the micro blogging system 122 is populated to the discussion board, and to the maintenance data record 118 of the pump. Additionally, well identifiers are used for well monitoring 108, optimization 114, and tracking well production in the production history 110 and production schedule 112. Based on interdependencies, events can have a variety of root causes, and can be fixed in a number of different ways, as discussed further below.

Referring generally to FIG. 1, several assumptions by current CEP systems, such as availability of homogeneous type of event sources or unchanging data structure and schema, are not true in real world scenarios such as the modern oil field 102, which comprises of heterogeneous and dynamic data sources with complex dependencies across that oil and gas enterprise. In the scenario of a pump failure in an oil field 102, the complex data mappings between various event knowledge sources such as sensors involved in supervisory control and data acquisition (SCADA) systems, real-time well monitoring and operations systems, historical well failure data, equipment databases and the enterprise social networks can be illustrated in FIG. 1.

Still further referring to FIG. 1, in the context of the oil field 102, various teams such as project, operations, maintenance and optimization employ different systems including equipment life-cycle systems, hydrocarbon accounting systems, maintenance management systems and production optimization systems. In case of an event such as a well failure, the users are required to collaborate across these team (and system) boundaries, but are inhibited because of the lack of integration. Coordinated actions and roles allow for definitions of coordinated responses, as further discussed below in connection with the events, actions, roles, and notifications discussed herein.

Referring now to FIG. 2 a schematic block diagram of a computing system 200 is shown. The computing system 200 can be, in some embodiments, used to implement a complex event processing system. In general, the computing system 200 includes a processor 202 communicatively connected to a memory 204 via a data bus 206. The processor 202 can be any of a variety of types of programmable circuits capable of executing computer-readable instructions to perform various tasks, such as mathematical and communication tasks.

The memory 204 can include any of a variety of memory devices, such as using various types of computer-readable or computer storage media. A computer storage medium or computer-readable medium may be any medium that can contain or store the program for use by or in connection with the instruction execution system, apparatus, or device. In the embodiment shown, the memory 204 stores a complex event processing application 212, discussed in further detail below. The computing system 200 can also include a communication interface 208 configured to receive data streams and transmit notifications as generated by the complex event processing application 212, as well as a display 210 for presenting various complex events, or issues relating to a system under observation, or allowing a user to define entities within a system to be monitored, or events to be monitored by the application 212. As such, in the embodiment shown, the complex event processing application 212 acts as a monitor on the data streams received via the communication interface 208.

Generally, the complex event processing application 212 includes event profiles 214, as well as information defining a dynamic system 216 that is monitored via data streams. The application 212 also includes an action-role mapping component 218, a role-actor mapping component 220, and a set of notification rules 222. The application 212 includes a state transition engine that maintains a set of state transition models 224 for the entities under observation in the data stream, as well as other complex event processing data 226 and an event escalation component 228.

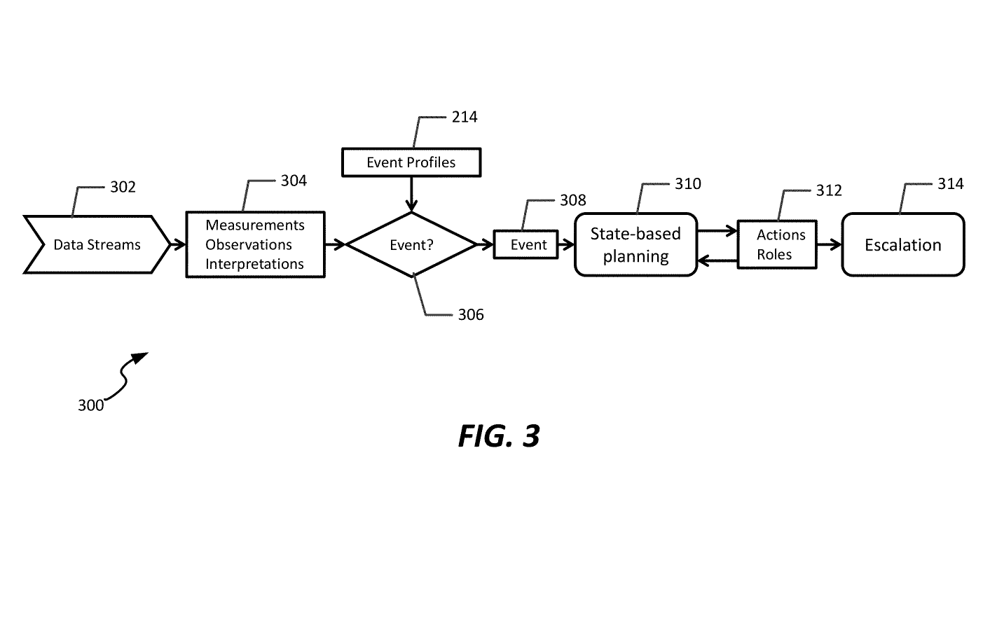

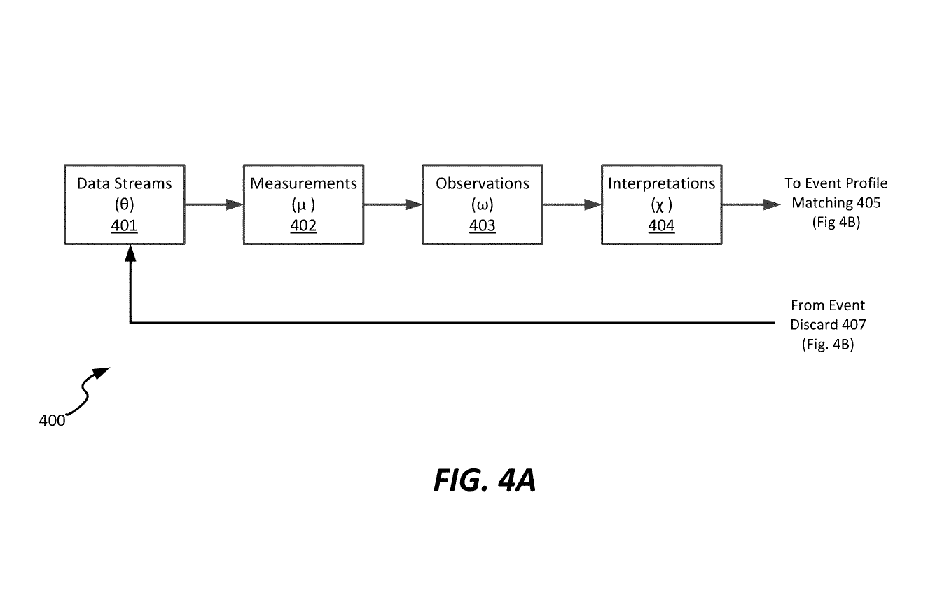

The event profiles 214 are defined in memory and used by the application 212, as discussed below in connection with FIGS. 3 and 4A-4B, to determine whether any change in data detected in a data stream received by the computing system 200 represents an event of interest to the application 212. This can be based on a number of factors, such as patterns or changes over time. Events generally refer to occurrences of interest in a system being monitored, and can include either simple or complex events. A simple event is directly observable, while a complex event, as discussed herein, corresponds to the interpretation of an observation of interest that depends on multiple simple events. Events therefore represent an interpretation of an observation of interest, and can be expressed as follows:

eₛ=χ_{ω}_{^{κ,π,T}}

In the above expression, e is the event, T is a timestamp of the event, κ is the entity associated with the event, π is an observable property associated with the entity for which the event was recorded, and χ corresponds to a chosen interpretation of an event. As further explained in the examples below, in various usage scenarios, the events can correspond to simple or complex events, each having different event profiles. A complex event, constructed from multiple simple events, can generically be represented as:

e_{c}=X_{ω}_{^{κ,π,T}}

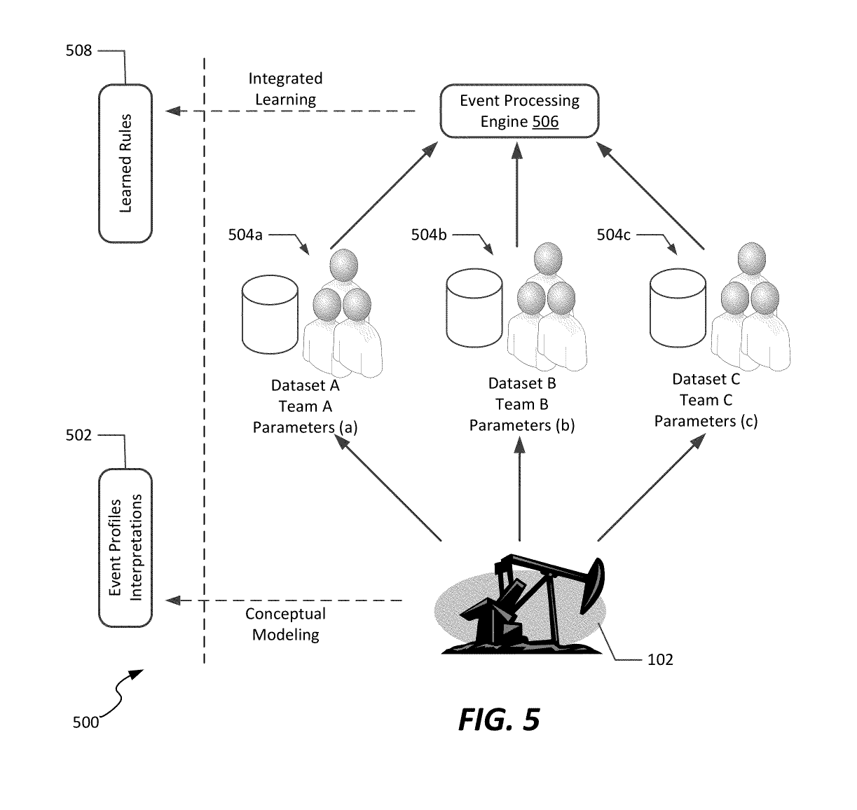

Example event profiles, including those for both simple and complex events, are discussed below in connection with FIGS. 6-9.

The information defining a dynamic system 216 generally defines a system being observed. The system being observed, in the context of the present disclosure, generally corresponds to a dynamic system that generates a data stream that can change at a high rate, such that event detection and response is desired. In the context of the present disclosure, the system is made up of entities; for example, a particular oil exploration site may include a number of wells, and each well may include various equipment, including one or more pumps. Each of these features of the system can correspond to an entity, as can each of the employees at the site or other people or objects of interest or relevance (physical or logical) to the application 212. The information defining a dynamic system 216 can also define one or more observable properties, each of which are associated with an entity and correspond to features of that entity. Additionally, the information defining a dynamic system 216 can include measurements that represent a type of observation that can be made, and observations, which are the specific measurements made at a particular time. Based on the information defining a dynamic system 216, the data stream received at the communication interface 208 can be interpreted as observations associated with a particular entity, as per a specific measurement model.

The action-role mapping component 218 acts as an action determination component used to define one or more actions that can be performed within the system in response to a detected event by the application 212, and associated actors (i.e., roles). The actions can be, for example, actions that are relevant to state-changes for a particular entity. For example, actions defined in the action-role mapping component 218 can be associated with state transitions of observed entities, as discussed further below. It is possible to determine actions that lead to the desired state. Since these actions are specific to a real-world business or organizational context we identify them as domain actions. In the case of an oil field, actions performed by operators, maintenance engineers and other teams are domain-specific and therefore classified as domain actions.

In addition to domain actions, complex event processing also requires certain actions to be performed in order to detect and process events. For instance, on detection of simple events, complex event profiles should also be reviewed. Once simple and complex events are identified, the approach should lead to identification of states and necessary processing actions (such as notification to subscribers) required in response to the detected event. These actions are identified as “CEP” actions.

A third type of action is required to implement the CEP actions. For instance, CEP actions provide a list of tasks to be performed at specific time instances or intervals. However, these tasks are realized in the form of database queries, computations, or other computing occurrences. These set of tasks are performed electronically in the specific system implementation, thus identified as system actions or middleware actions.

The role-actor mapping component 220 acts as a role determination component configured to determine, based on the action to be taken and the role able to perform the action, the particular role or actor to be notified or who is associated with the particular event. For the identified domain actions, a person who is interested or responsible in specific actions and resulting state transitions can be identified for playing the role of the actor. Here, a person or an agent can be responsible/capable of performing specific domain actions, therefore the role can be identified as a domain role. In an oil field scenario, a person responsible for maintenance of a failed pump can be considered to play a domain role of maintenance engineer. However, roles can be of various types and can be played by real-life or logical (software agent) entities. In case of CEP actions, the corresponding roles can be identified. For instance, the CEP application 212 can perform a query to determine the recipient of the notification message about the detected event. In other words, publisher and subscriber roles can be identified for a given event. Notably, an actor playing a domain role (e.g., maintenance engineer) may also be assigned a CEP role (e.g. event subscriber). Additionally, system or middleware roles can be included that determine various middleware actions performed by a software agent. For instance, a software agent responsible for determining subscription to events can be assigned a role of broker. Similarly a software agent responsible for generating event related information can be identified as the role of publisher.

The notification rules 222 operate as a notification component that is useable to define notifications that are to be generated once an event is detected and corrective actions and roles are identified. The application 212 stores example content for use in such a notification, such as an instruction for corrective action, or an expected time of completion. In some embodiments, discussed in further detail below in connection with FIG. 3, if the action is not taken and entity remains in the same state, the application 212 may trigger additional work flows to escalate the event. In addition to expected time of completion, the application 212 might include in the notification best practices related to the required action and additional information that is available in the background knowledge base.

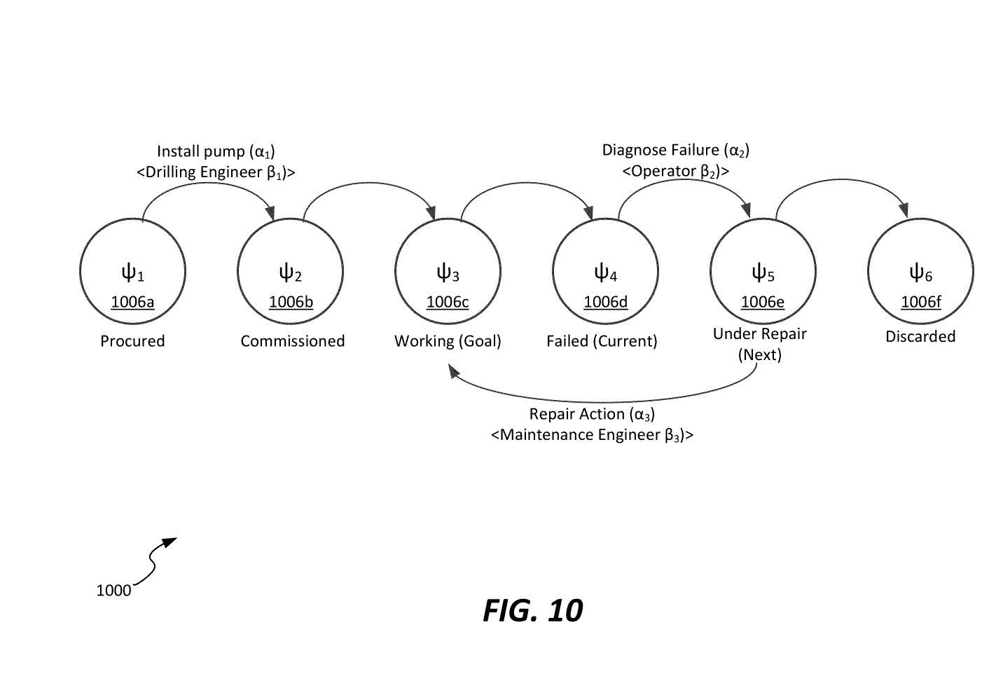

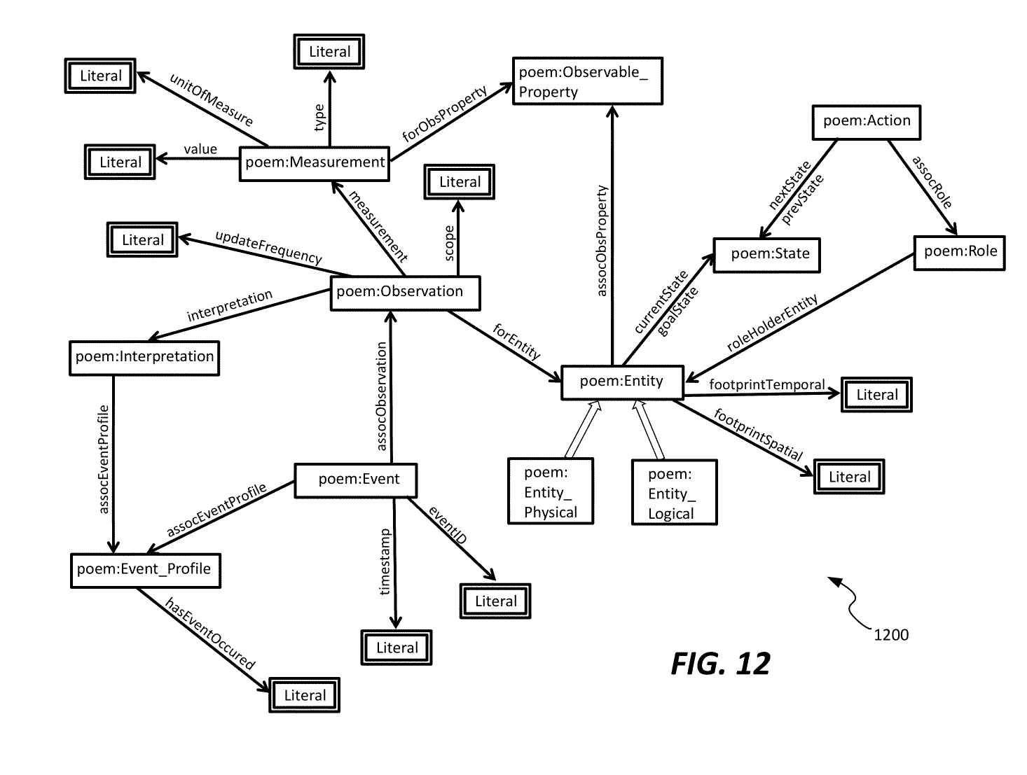

In traditional complex event processing systems, changes in state are used to track whether an event has occurred. However, in embodiments discussed herein, the state transition models 224 define a set of state models, such as either deterministic finite automaton (DFA) or nondeterministic finite automaton (NFA) state models, that can be used to perform complex event detection by modeling states in a system to determine actions to be taken. In contrast to traditional use of state models for event detection, the state models described herein specify the sequence of states which should be propagated so that an entity can reach its desirable goal state. It is also the basis for determining actions which are responsible for transition in states so that the system can undertake these actions as specified by the sequence of states to reach the goal state. In some cases, states of the particular state machines correspond to states of the entity, with input symbols into a state machine corresponding to actions to be taken. State transition model storage 224 can include state transition models for each entity of interest within a particular dynamic system, one example of which is illustrated in FIG. 10, below. For instance, as illustrated in that example, if a pump is found to be in a faulty state of a state transition model and it is not possible to repair it, the state transition model could dictate to automatically move that pump to a decommissioned state without any explicit action. Additional examples are illustrated in FIGS. 12-15, also discussed below.

The complex event processing data 226 generally corresponds to stored data associated with a dynamic system under observation, and can include historical data received via a data stream from subsystems of the dynamic system for use in connection with detecting one or more event profiles, or can include stored (dynamic or static) data describing one or more subsystems of the dynamic system, or the system overall.

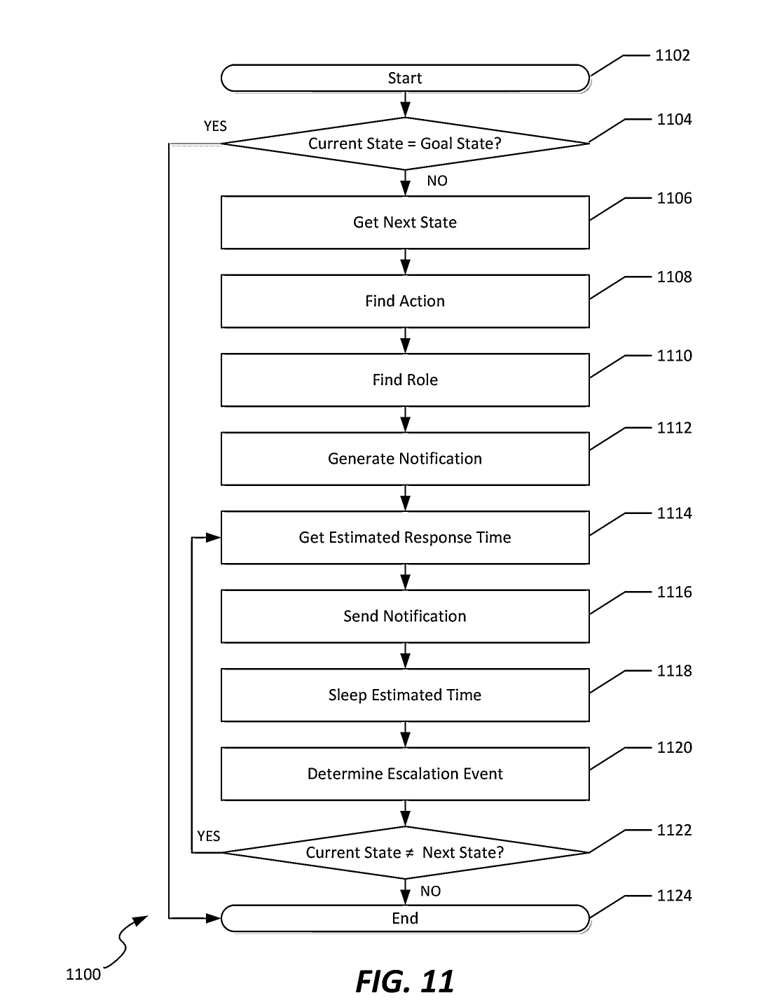

The event escalation component 228 generally provides for monitoring of states defined in the state transition models 224 and event escalation in case state transitions do not occur based on the defined actions and roles, and associated notifications defined in the notification rules 222. The event escalation component 228 defines example escalation processes that can take place in the event that a particular event that requires a responsive action is not acted on. An example of operation of the event escalation component is discussed in further detail below in connection with FIG. 11.

Referring to FIG. 2, generally, it is noted that although a single computing system 200 is shown logically in the figure, it is recognized that one or more such systems could be used to implement aspects of the complex event processing application 212 described above, and therefore to implement a complex event processing system useable to monitor and address issues detected in a dynamic system under observation.

Referring now to FIG. 3, a flowchart of a process 300 performed by a complex event processing system to detect and address events is shown according to an example embodiment. The process 300 can be performed, for example, by the computing system 200 and associated application 212 of FIG. 2, above. In the embodiment shown, one or more data streams 302 are received from a dynamic system, for example from entities within the dynamic system at a computing device implementing the complex event processing system. Those data streams would be processed to determine the existence of one or more measurements, observations, and/or interpretations on the data (step 304). This can include detection of particular data, trends in data, states of underlying components based on the data, or other observable effects. An event profile matching process then compares the measurements, observations, and interpretations to one or more event profiles 214 (at step 306). Upon detection of an event 308, a state-based planning operation 310 generates one or more actions to be provided to persons or entities having specific roles or responsibilities relative to the process represented by the data stream 302 (at step 312). The actions and roles are then processed, for example by notifying appropriate systems or personnel (e.g., roles) to take specific actions based on the event detected (step 312). Such actions may cause changes to a state of the underlying system (again, at step 312). Optionally, in the event that a goal state is not reached, one or more escalation processes can be performed to raise a priority level or otherwise change the response to the detected event to encourage a goal state to be reached (step 314).

Referring now to FIGS. 4A-4B a more concrete example of a process 400 is shown, according to a further example embodiment. In the embodiment shown, a process 400 performed by a complex event processing system to detect and address events is shown. The process 400 can be performed, for example by the computing system 200 and associated application 212 of FIG. 2, above. In the embodiment shown, and in particular in FIG. 4A, one or more data streams 401 are received from a dynamic system, for example from entities within the dynamic system, at a computing device implementing the complex event processing system. Example aspects of a data stream in the context of an oil well could be temperature or pressure sensor readings. The data stream 401 is then analyzed to generate one or more measurements 402 of that data, which adds further context to the data stream by adding a unit of measure, measurement type, and bounds to the data values in the data stream 401. For instance, temperature is an observable property that can be measured using digital and analog sensors (thermometers). Thermometers may provide readings in degrees Celsius or Fahrenheit. Also, sensitivity of the measuring device may vary significantly thereby affecting precision and accuracy. Some sensors may provide a continuous stream of readings, whereas others may provide readings at several intervals.

Additionally, one or more observations 403 can be obtained, which correspond to abstractions of measurements that deal with instantaneous or periodic measurement values. As such, the observations 403 have a temporal context associated with them that causes those abstractions to be valid only while the measurements are current or valid. Accordingly, observations correspond to measurements over time, providing context in addition to the measurement alone. Additionally, the observations can be used to generate interpretations 404, which add further context and understanding of the data stream 401. Interpretations may be a determination that a particular temperature or pressure is within a threshold of normal or critical values. Accordingly, FIG. 4A represents a parsing and understanding of context of a particular data stream.

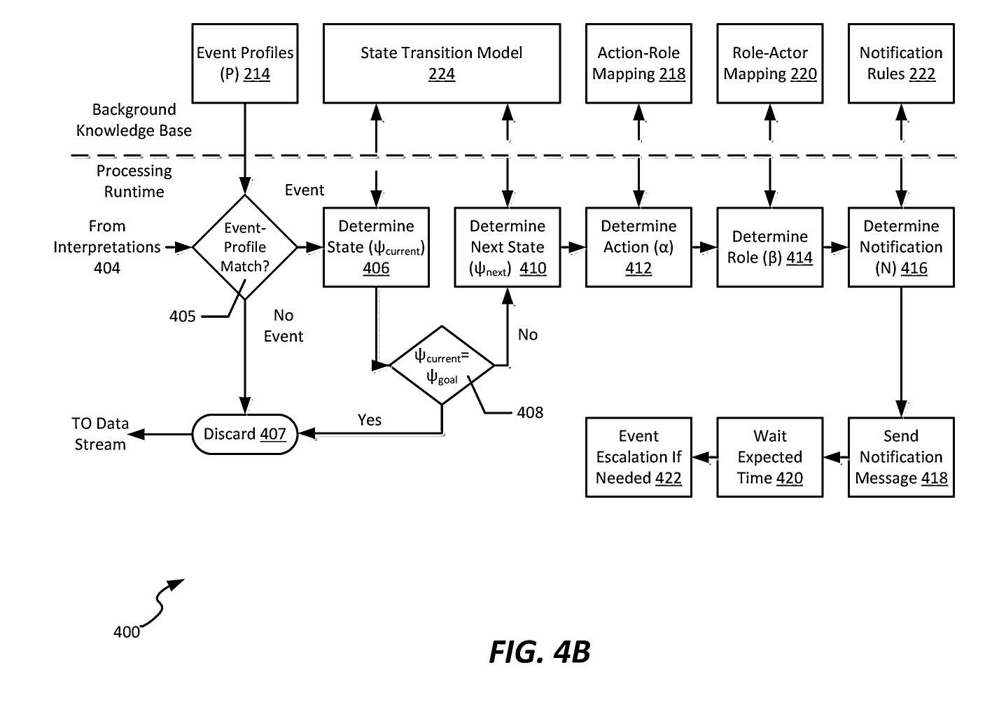

As further discussed below, the combination of measurements 402, observations 403, and interpretations 404 forms the understanding of whether or not an event has occurred. As noted above, in conventional event definitions, each change is declared as an event. However, in the present disclosure, events represent an interpretation of an observation of interest. By way of example in the oil field context, a “high temperature event” may correspond to obtaining a temperature from a sensor (the data stream 401) to which units are applied (a measurement 402). That measurement is then placed into context (e.g., scaled), to form an observation (e.g., 100 degrees absolute over a particular amount of time). Such an observation can be defined as a simple interpretation 404, such as a high temperature event. When a current interpretation 404 matches a defined event of the event profiles 214, that event can be detected, as illustrated in FIG. 4B. Example event definitions for more complex events are discussed below in connection with FIGS. 5-11. In example embodiments, interpretations of observations can be defined as interpretation sets defined based on piece-wise linear functions, Boolean functions, or other suitable mathematical or logical representations recommended by domain experts. The branches of the interpretation set are, in such embodiments, mutually exclusive and only one is generally activated during a certain event.

Referring now to FIG. 4B, the parsed data stream can now be compared to event profiles to detect events. In particular, an event profile matching process compares the received data in the data stream 401, as well as one or more measurements 402, observations 403, and interpretations of that data 404, to event profiles 214 (step 405) to detect an event. If no event is detected, that potential event is discarded (step 407), and the process continues based on subsequent data received from the data stream 401, measurements 402, observations 403, and interpretations 404 of FIG. 4A. However, if an event is detected based on the event profiles (described in further detail below in connection with FIGS. 6-9), a current state of that particular entity experiencing the event is determined (step 406). For example, in an oil field context, this may represent a pump entity that has failed, and is in an error state. The state transition model storage 224 is consulted to determine whether the current state of the entity corresponds to a goal state of the entity.

If the entity is currently in a goal state (e.g., for a pump, an “operational” state may be designated in a state diagram, as illustrated in FIG. 10), that event is again discarded (step 407). However, if the entity is not in a goal state, the entity may need to transition through one or more states to arrive at that goal state. As such, the state transition model storage 224 is consulted to determine what a “next” state should be to eventually arrive at the goal state (step 410). Based on the current and goal state, the action-role mapping defined in the action-role mapping component 218 determines an action to be performed based on the change of state that is desired (step 412). Once the action is determined, an actor is determined that is best suited to perform the action, as defined in the role-actor mapping component 220 (step 414). A notification can then be generated to be transmitted to the actor based on notification rules 222 (step 416).

In some embodiments, before notification is provided, a filtering operation can be performed which determines how similar events, or events close in time, have been handled. Such a filtering step may be advantageous to avoid duplicate notifications to various parties, which may cause confusion.

Once the notification is transmitted to the appropriate actor or actors who may be required to (or wish to) be notified in the case of a detected event and a requested action in response, the complex event processing system can optionally incorporate a feedback component that defines a predetermined, expected time to wait for that action to be performed by one or more of the actors to whom the notification message was sent. For example, in the case of a problematic or malfunctioning pump, a maintenance request could be sent to a maintenance engineer, and can include an expected response time (step 420). After that expected response time, if the action has not yet taken place (as detected by an event in the input data streams 401, measurements 402, observations 403, and interpretations 404), an event escalation could occur, which corresponds to a message fed back into the data to be analyzed by the complex event processing system (step 422). In the event of such an escalation, a different state transition may be implicated, or different actions, roles, or notifications may occur. Continuing the above example of a maintenance request to be serviced by a maintenance engineer, should that maintenance engineer fail to correct the pump malfunction within a predetermined amount of time, one or more other maintenance engineers, supervisors, or other personnel may be notified, and/or one or more surrounding pieces of equipment (i.e., entities) may be notified to shut down due to a potential for malfunction (if those pieces of equipment rely on and assume continued operation of the pump).

Now referring to FIGS. 5-11, various components of the complex event processing system are described in greater detail. FIG. 5 is an example illustration of a data sharing arrangement 500 for collecting knowledge used in the complex event processing system to detect and build a set of event profiles, according to an example embodiment. The arrangement generally includes a dynamic system under observation, such as an oil field 102. The data sharing arrangement includes a set of event profiles and interpretations 502 that are based on conceptual modeling of the dynamic system under observation, as may be defined by a user of the complex event processing system.

The dynamic system under observation can be separated into a plurality of subsets 504a-n, which each can include a dataset, a team of individuals (actors) or entities associated with that dataset, and parameters that are relevant to that subset (e.g., observable properties, and types of actions that can occur). These subsets can be passed to an event processing engine 506, which can provide integrated machine learning regarding events that take place, which are stored in a learned rules component 508. The event profiles and interpretations 502 and the learned rules component 508 make up a knowledge base regarding the dynamic system under observation, from which events can be detected.

Referring now to FIGS. 6-9, simple and complex events are illustrated that indicate how to define event profiles to the complex event processing system of the present disclosure. A simple event is generally an occurrence of interest that is reflected in observed data in a data stream, such as data stream 302 of FIG. 3, or data stream 401 of FIG. 4A. Each of the simple and complex events are predefined based on knowledge gained regarding the dynamic system under observation, as indicated in FIGS. 3 and 4A-4B, above. A complex event, as discussed herein, corresponds to the interpretation of an observation of interest that depends on multiple simple events. In order to obtain complex events, composition of simple events using logical or temporal operators such as conjunction, disjunction, negation or sequence is performed. Using a combination of these operators, it is possible to build complex rules for representing real world event processing scenarios, especially for detecting complex events.

FIG. 6 is an example definition of a simple event profile 600. In the embodiment shown, the simple event profile 600 takes the form of a basic temperature event occurring in a well, capable of being defined in the complex event processing system described herein. As illustrated, each event profile 600 is defined by one or more entities (κ) 602, observable properties (π) 604, measurements (μ) 606, observations (ω) 608, and events (e) 610. The event profile 600 typically involves a query that is used to determine if a specific event 610 has occurred. Event profiles suggest what data needs to be queried to determine the occurrence of an event. For a simple event, the event profile consists of just an observation that can be performed once or repeated at specific time intervals. For example, a simple event profile that requires a single (one-time) observation of property π (e.g., temperature, pressure, motion, etc.) for an entity κ (e.g., a pump, operator, vehicle, database, etc.) at time instance T can be represented as Pₛ^{o}=ω^{κ,π,T}. However, in real world scenarios, the requirements can be complex. For example, an event profile may constantly need to be evaluated at a specific time interval. In such scenarios, a recurring event profile can be represented as:

Pₛ^{r}=ω^{κ,π,Δτ}

Hence, an event profile for checking the temperature of a pump every 30 seconds could be expressed as:

Pₛ^{r}=ω^{pump,temp,30 sec}

In the embodiment shown, the event profile 600 includes an entity 602 as a pump, having an observable property 604 of temperature. A measurement 606 of that observable property 604 corresponds to a temperature reading, and the observation 608 is a numerical reading of the temperature. The reading of the temperature is 100 degrees absolute, which, by referring to the interpretations for the pump leads to the identification of a simple event 610. The defined simple event 610 based on these occurrences is a high temperature event of the pump.

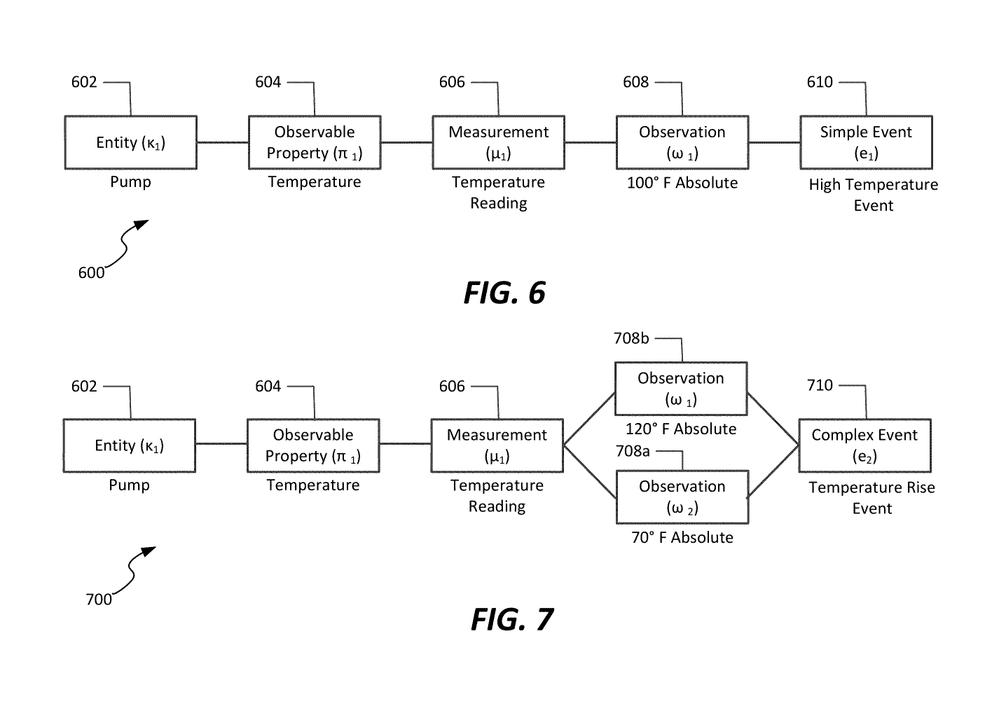

FIG. 7 is an example definition of a complex temperature change event profile 600 occurring in a well, capable of being defined in the complex event processing system described herein. As previously mentioned, multiple observations related to the same entity and observable property taken at different times can lead to a complex event. For instance, the sequence of two atomic events occurring within a temporal distance is a complex event that can be denoted as:

P_{c}^{o}?=ω^{κ}^{₁}^{,π}^{₁}^{,T}^{₁}Λω^{κ}^{₁}^{,π}^{₁}^{,T}^{₂}

In the example of FIG. 7, this scenario is shown in the context of a temperature change event, based on interpretations involving two observations of the same property at different times. In this scenario, the difference in temperature observations 708a-b exceeds a predefined limit thereby triggering a temperature rise event (e₂) 710.

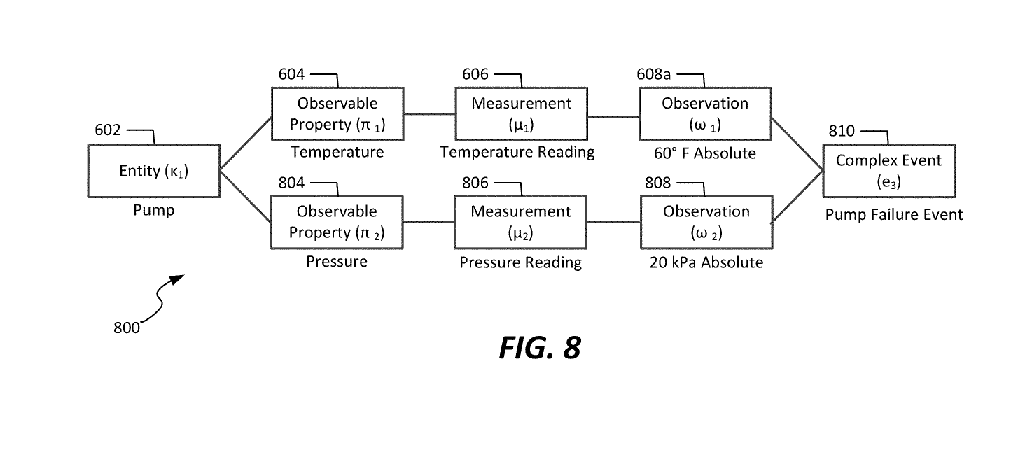

FIG. 8 is an example definition of a complex pump failure event profile 800 occurring in a well, capable of being defined in the complex event processing system described herein. In this example, different observable properties associated with the same entity are combined to define the complex event profile, which can be denoted as:

P_{c}^{o}=ω^{κ}^{₁}^{,π}^{₁}^{,T}^{₁}Λω^{κ}^{₁}^{,π}^{₂}^{,T}^{₁}

In particular, event profile 800 represents a complex event caused by measurements in two different observable properties (temperature and pressure) of the same pump entity. In the embodiment shown, the pump entity 602 has two observable properties, temperature (property 604) and pressure (property 804). Measurements of each, corresponding to a temperature reading 606 and a pressure reading 806, result in separate observations 708a (temperature value of 60 degrees), 808 (pressure of 10 kPa). Based on these two concurrent readings, a pump failure event 810 can be detected.

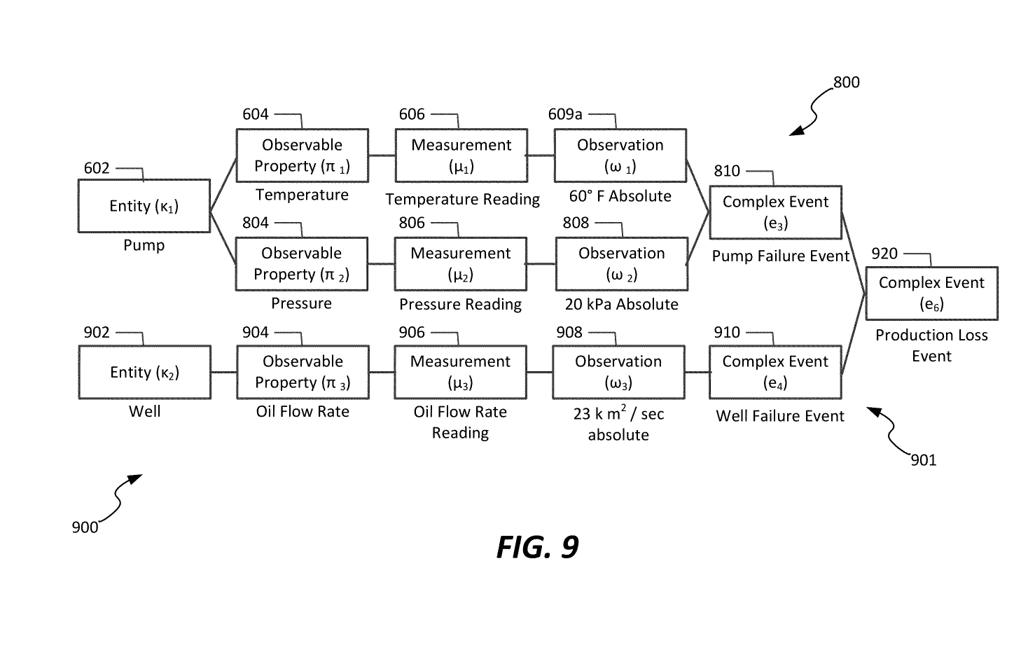

FIG. 9 is an example definition of a complex production loss event profile 900 occurring at a drilling site and capable of being defined in the complex event processing system described herein. The event profile 900 corresponds to involvement of multiple entities, which may or may not be of the same or different type. As illustrated in the event profile 900, an event profile involving two different entities may simply be shown as the intersection of the two related simple events, as follows:

P_{c}^{o}=ω^{κ}^{₁}^{,π}^{₁}^{,T}^{₁}Λω^{κ}^{₁}^{,π}^{₂}^{,T}^{₂}Λω^{κ}^{₂}^{,π}^{₃}^{,T}^{₃}

In particular, event profile 900 generally corresponds to event profile 800 intersecting with a well failure event profile 901. The well failure profile 901 includes an entity 902 of a well, an observable property 904 of an oil flow rate, a measurement 906 defined as a flow rate reading, and an observation 908 corresponding to that reading being at 23 km³/sec. Based on these properties and observations, a well failure event 910 (a simple event) can be defined. Additionally, the combination of the well failure event 910 and the pump failure event 810 of FIG. 8 can correspond to a production loss event 920.

It is noted that, as indicated in FIG. 9, a combination of any of multiplicity in any of the above criteria outlined in FIGS. 7-9 can cause a complex event. To illustrate this scenario, consider FIG. 9 where the entity, observable property and observations are all different. It indicates an interpretation where a complex event of production loss in the oil field is triggered by multiple sub-events and observations. Furthermore, and based on which combinations of events are detected, and states defined in the corresponding state diagrams for those entities, different actors, roles, or notifications may be generated in the complex event processing system. In such cases, various conjunction or disjunction sequences can be used to describe event profiles. Additionally, negation of various events could be used as well. In general, a complex event can be described as an interpretation of an observation of interest that depends on multiple simple events, represented as:

e_{c}=X_{ω}_{^{K,Π,T}}

In the above equation, K represents the set of entities associated with a complex event, Π represents the set of observable properties, T is the timestamp of the complex event, and X is the interpretation of the complex event.

Referring now to FIG. 10, an example state transition diagram 1000 is shown for a pump, capable of being defined in and applied by the complex event processing system described herein. In general, the state transition diagram 1000 can be one of a number of state transition diagrams included in the state transition model storage 224 of FIGS. 2-3 and 4A-4B, above. In the embodiment shown, the state transition diagram 1000 includes a plurality of possible states (ψ₁₋₆) of the pump, including a procured state (ψ₁) 1006a and a commissioned state (ψ₂) 1006b. The state transition diagram also includes a working state (ψ₃) 1006c, a failed state (ψ₄) 1006d, and an under repair state (ψ₅) 1006e. A discarded state (ψ₆) 1006f is also included, for use in defined state transitions in which repair is unsuccessful.

When used in the context of the complex event processing system discussed above in connection with FIGS. 2-3 and 4A-4B, one or more of the states 1006a-f can be defined as a “goal” state. In the example shown, the working state (ψ₃) 1006c is noted as the goal state in the state transition diagram. When, based on an event, it is determined that, for example, a failed state (ψ₄) 1006d is the current operational state, the state transition diagram can be consulted to determine that a next state to be entered is the under repair state (ψ₅) 1006e. Based on this transition, a notification message can be generated to issue a diagnose failure action to an operator, as indicated in the state transition diagram.

Once in the under repair state (ψ₅) 1006e, a further traversal of processes 300, 400 (e.g., based on an event of detecting this change in state of the pump) may result in issuance of a repair action to a maintenance engineer in a notification message, to cause transition to the working state. If that transition does not occur, over the course of that or subsequent attempts (or escalation events generated by the complex event processing system), an action to transition the pump to a discarded state (ψ₆) 1006f may be issued to the pump and to a maintenance engineer, deactivating the pump and indicating to that maintenance engineer to remove the pump from the dynamic system under observation by the complex event processing system.

In connection with the state diagram of FIG. 10, it is noted that for complex event processing to assist in directing a system to a goal state, various actions should be defined that allow for performance of operations based on the observed events. The actions represent necessary processing actions (such as notification to subscribers) that are required in response to a detected event. One or more Event-Condition-Action rules (e.g., the notification rules 222 of FIG. 4B) define actions to be taken for various events, including both detected events and event escalations.

Now referring to FIG. 11, a flowchart is shown that illustrates an example event escalation process 1100. The event escalation process 1100 is useable in connection with the process 400 performed by the complex event processing system of FIG. 4A-4B, to detect and address events, and can include, in some cases, steps 406-422 of that process.

In the embodiment shown, the process is instantiated at a start operation (step 1102), which can correspond to initial determination of whether some type of action should take place, in case an event profile is matched and an event has been detected. The process 1100 also includes determining whether the current state of the particular entity experiencing the event is the same as that entity's goal state (step 1104). If the current state is not the goal state, a next state is determined (step 1106), and an action, role, and notification are generated (steps 1108-1112), analogously to the manner described above in connection with steps 412-416 of FIG. 4B.

In the embodiment shown, a response time is next determined (step 1114), which corresponds to an estimated time that may be required to transition between the current state and a next state of the entity, for example based on a state transition diagram associated with that entity (e.g., as illustrated in FIG. 9, above in the case of a pump). The generated notification is sent (step 1116), analogously to step 418 of FIG. 4B, and a sleep event (step 1118) occurs, causing the complex event processing system to wait for the predetermined time (as in step 420 of FIG. 4B). An escalation event is determined and acted upon (step 1120), for example by determining a next actor to which the notification message is to be sent, or a next notification message to be generated. The current state is then assessed to determine if it has reached the next state (i.e., the determined next state as determined in step 1106) (step 1122). If the current state is not, after the estimated time, equal to the next state, operation returns to step 1114, in which the estimated response time for that subsequent escalation event is determined, and accordingly the process continues when the escalated notification is generated (step 1116). If the current state is, instead, equal to the next state as determined in step 1122, or if the current state is in the goal state (as determined in step 1104), operational flow terminates at an end operation (step 1124), indicating completion of actions causing a state transition, including any necessary escalation that may occur.

It is noted that, in various embodiments, it may be required to traverse two or more states to return to a goal state from a current state. As such, in some embodiments, when a current state and next state are determined, it is possible to determine a set of next states, and corresponding set of next actions and roles, required to cause transition to the goal state from the current state.

FIG. 12 illustrates a general-purpose process-oriented event model 1200 useable to implement event definitions according to a possible embodiment. Generally, the event model 1200 includes a plurality of classes (shown as rectangles), and literals (shown as double rectangles), as well as object-type properties associating the various classes. The event model described herein enables connection of existing information to open data. For example, time-related concepts can be borrowed from a W3C Time ontology, and geospatial concepts can be reused from the Geonames ontology for use in the existing event definitions. Use of such a model 1200 also enables comparison against existing models, such as the Simple Event Model (SEM), and provides cross-links to other models.

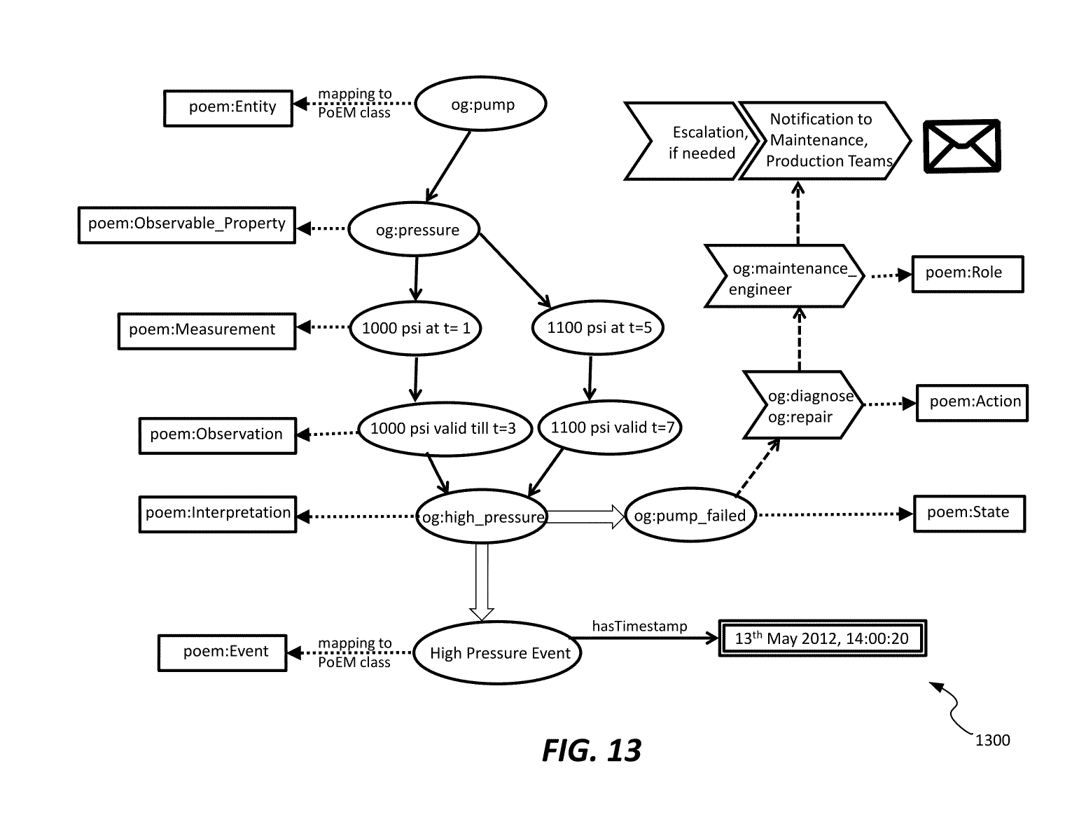

FIG. 13 shows a particular implementation of a model 1300 depicting a pump failure scenario in an oil field, as described in connection with FIG. 1. In this example, a pump (i.e., an entity in the event model) includes sensors used to monitor the pressure by the load on the pump. In such cases, excessively high or low pressure values can lead to anomaly events. Accordingly, an event detection rule that detects rapid rates of change in a pressure value of the pump could utilize a known measurement value (e.g., pressure units such as Pascals or PSI) and could define a quick change of a predetermined, measured amount as an indicator of a pump failure event. As seen in FIG. 13, an observable property of pressure (from a data stream 401) could be converted to a measurement 402, and that measurement converted to an observation 403 by applying a time criteria (e.g., maintaining a high pressure reading for a particular period of time). That observation can be correlated to an interpretation of a high pressure event, which is compared to an event profile 214 to determine the existence of a pump failure event. In such cases, the state of the pump may change; in the example shown, a pump_failed state is entered. Accordingly current and goal states are detected and identified, and a sequence of actions are determined that would be required to move the pump from the current state (failed) to the goal state (operational). Associated roles for each action are queried and determined, and relevant persons or systems are notified (e.g., maintenance engineers). In some cases, other notifications may be generated as well, for example to other interested parties (e.g., a production team). Furthermore, an escalation mechanism can be used to notify others if needed, reducing response times and improving production times.

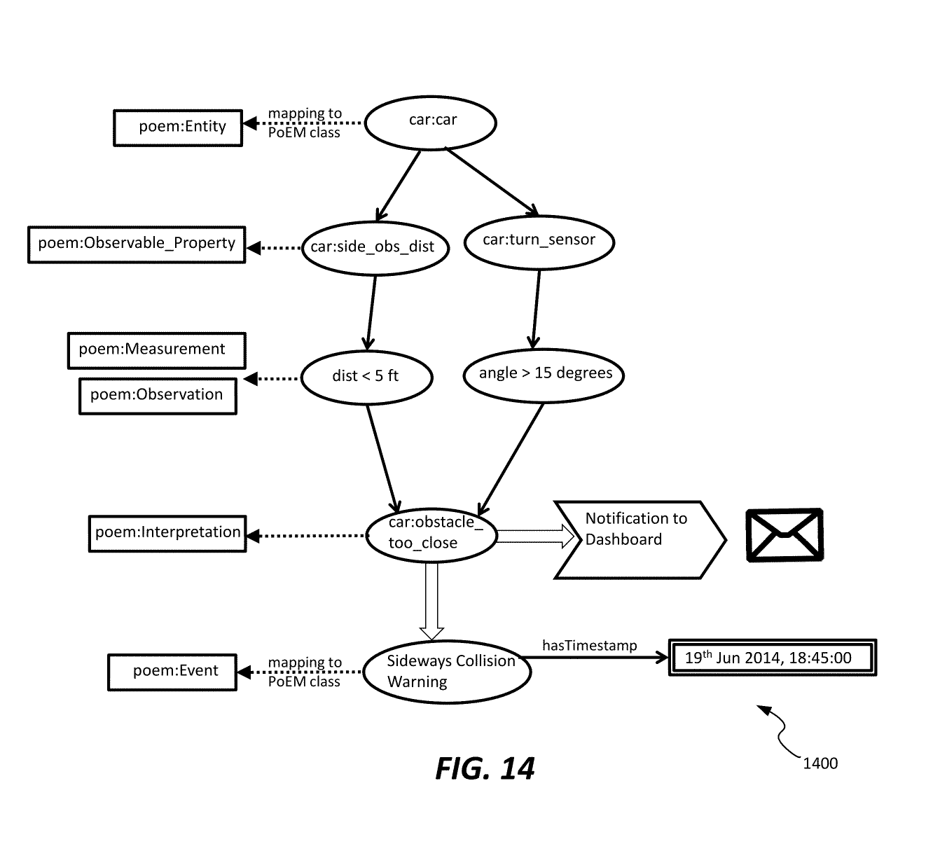

It is noted that, although discussed in the context of an oil well or oil field operation, other arrangements are possible as well, in other industrial or mechanical processes. Referring now to FIG. 14, an example automatic sensor measurement system 1400 is described using the process oriented event model described herein in the context of automobile collision avoidance. In this example, the system 1400 includes an entity (a car) to which observable properties are mapped (e.g., a turn sensor activation, and an existence of an object to the side of the automobile). One or more measurements and qualitative observations are next provided. In this example, the measurements can be one of distance and angle toward the object, and the observations can represent a particular threshold or change in distance or angle over time. Such observations can then be interpreted (e.g., as an obstacle being too close), which can, upon matching to a sideways collision warning event, trigger a timestamp at which the event occurs, and generate a notification to a dashboard to warn a driver (e.g., a notification, as described above). This notification may have the goal of indicating to the driver to correct course of the automobile to avoid the object, and return the car to a goal state in which a sideways collision warning does not exist.

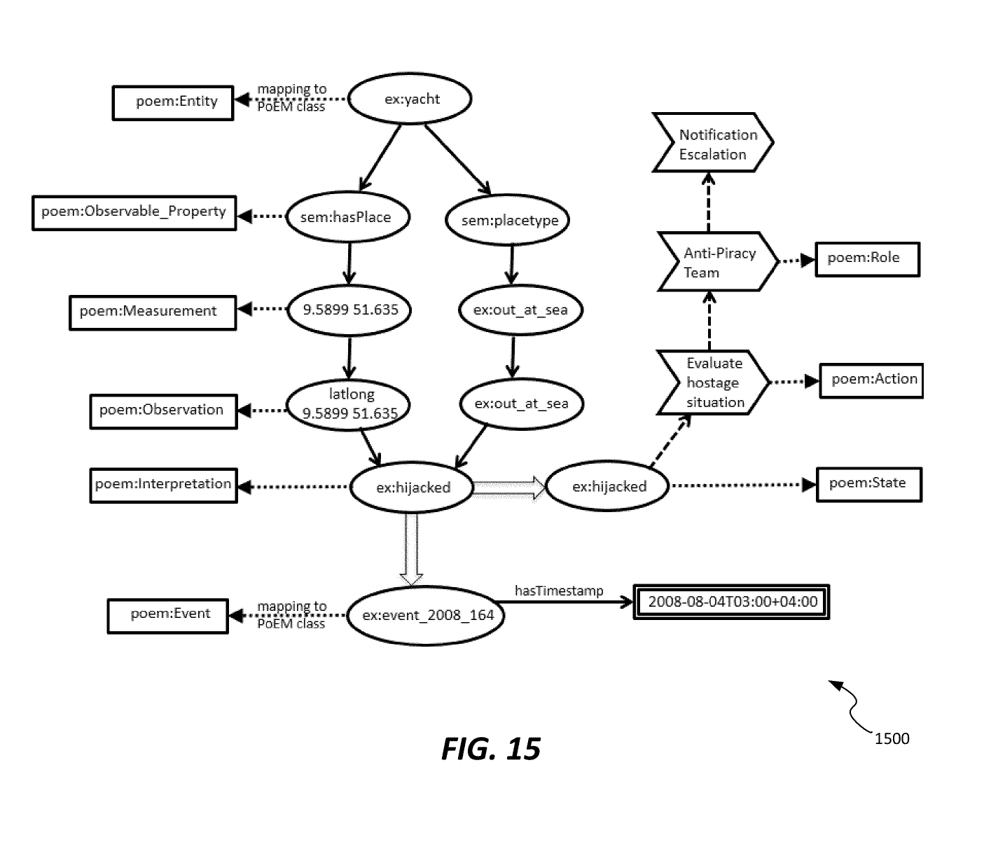

Referring also to FIG. 15, a further example of application of the process-oriented event model described herein is shown, generally outside the context of an industrial process. In the example shown, an ocean piracy detection model 1500 is illustrated. In this example, a particular entity (e.g., a yacht) has an observable property (e.g., a location) that is measurable and observable (e.g., at a particular latitude and longitude that indicates it is “at sea”). Based on that observation, the model 1500 allows an interpretation to be compared to known events defined by corresponding entities, and observed, measured properties. In this case, the interpreted event, “hijacked”, results in assignment of a “hijacked” state. Based on that state, an evaluation action is assigned to an anti-piracy team (i.e., the role assigned for that action), and notifications and/or escalations to other interested parties may occur. Based on the evaluation, one or more additional actions may be defined to assist in returning the system to a goal state (e.g., “normal”) from the current “hijacked” state.

It is noted that other example event definitions or events could be defined using the models described herein, according to various embodiments of the present disclosure. As such, the above described examples are intended as exemplary rather than limiting.

Referring generally to FIGS. 1-15, it is noted that, although certain embodiments are disclosed herein in the context of an oil field and oil field components, it is noted that the complex event processing systems and methods of use described herein have a number of further applications and implications. Further discussion of the systems described herein is provided in three papers:
(1) 0. Patri, V. Sorathia, A. Panangadan, V. Prasanna. “The Process-oriented Event Model (PoEM)—A Conceptual Model for Industrial Events”
(2) 0. Patri. “Towards Semantic Complex Event Processing for Dynamic Big Data Environments”
   Each of these papers is hereby incorporated by reference in its entirety.

Still referring generally to the systems and methods of FIGS. 1-15, and referring to in particular computing systems embodying the methods and systems of the present disclosure, it is noted that various computing systems can be used to perform the processes disclosed herein. For example, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, aspects of the methods described herein can be practiced within a general purpose computer or in any other circuits or systems.

Embodiments of the present disclosure can be implemented as a computer process (method), a computing system, or as an article of manufacture, such as a computer program product or computer readable media or computer recordable media. The computer program product may be a computer storage media readable by a computer system and encoding a computer program of instructions for executing a computer process. Accordingly, embodiments of the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media. Further, the disclosed methods' stages may be modified in any manner, including by reordering stages and/or inserting or deleting stages, without departing from the overall concept of the present disclosure.

The above specification, examples and data provide a complete description of the manufacture and use of the composition of the invention. Since many embodiments of the invention can be made without departing from the spirit and scope of the invention, the invention resides in the claims hereinafter appended.

1. A complex event processing system comprising:
a monitor configured to detect, from measurements received from one or more data streams, observations relating to the measurements, and interpretations of the observations, an occurrence of an event;
a state transition engine configured to receive the event and, based at least in part on the event, determine a current state of a particular entity of a dynamic system based on a state model as well as a next state of the particular entity to which the state model should transition, wherein the particular entity of the dynamic system is associated with the event;
an action determination component configured to determine an action to be taken based on the current state and the next state;
a role determination component configured to determine a role associated with the action to be taken; and
a notification component configured to generate one or more notifications to entities associated with the role, the one or more notifications including the action to be taken.

2. The complex event processing system of claim 1, further comprising a feedback monitoring component configured to wait a predetermined time for the action to be taken.

3. The complex event processing system of claim 2, wherein, based on whether the action to be taken has occurred, a feedback message is generated.

4. The complex event processing system of claim 3, wherein the feedback message results in an escalation event detected at the monitor, the escalation event resulting in the action determination component determining an escalation action to be taken.

5. The complex event processing system of claim 1, wherein the data streams are received from one or more entities of the dynamic system, and include one or more observations of observable properties associated with the entities.

6. The complex event processing system of claim 1, wherein the current state of the particular entity of the dynamic system is determined by the state transition engine.

7. The complex event processing system of claim 1, wherein the state model comprises an automaton comprising at least one of a non-deterministic finite automaton and a deterministic finite automaton, in which each state corresponds to a type of action performed by one or more entities of the dynamic system.

8. The complex event processing system of claim 1, wherein the event is associated with an entity of the dynamic system, a time, and a property.

9. The complex event processing system of claim 1, wherein the monitor detects an occurrence of an event based on a critical change observed in an entity of the dynamic system.

10. The complex event processing system of claim 1, wherein the action is selected from a group of actions including complex event processing actions, system actions, and middleware actions.

11. The complex event processing system of claim 1, wherein the role is selected from a group of roles including complex event processing roles, system roles, and middleware roles.

12. The complex event processing system of claim 1, wherein, if the current state of the particular entity of the dynamic system corresponds to the next state of the particular entity to which the state model should transition, discarding the event.

13. A method of processing complex events in an oil production system, the method comprising:
receiving a plurality of data streams from the oil production system at a complex event processing system;
defining measurements based on data in the data streams, and observations associated with the measurements;
detecting an occurrence of an event based on interpretation of the observations;
upon occurrence of the event, determining a current state of a state model;
if the current state is not a goal state, determining a next state to which the state model should transition;
based on the current state and the next state, determining an action, a role, and a notification to be generated; and
sending the notification and action to an entity assigned the role.

14. The method of claim 13, further comprising waiting a predetermined time after sending the notification for the action to be performed.

15. The method of claim 14, further comprising, if the action is not performed within the predetermined time, escalating the event.

16. The method of claim 15, wherein escalating the event includes providing feedback in the data streams received at the complex event processing system of non-action by the entity assigned the role.

17. The method of claim 16, further comprising, upon receiving the feedback, determining a second action, a second role, and a second notification to be generated that address the escalated event.

18. The method of claim 13, wherein detecting the occurrence of the event is based on matching one or more interpretations of the observations to one or more event profiles.

19. The method of claim 18, wherein the one or more event profiles each include a particular entity, an observation relating to a measurement of the entity, and an interpretation of the observation.

20. The method of claim 19, wherein at least one complex event profile includes a plurality of event profiles.

21. The method of claim 13, wherein the action includes a plurality of actions, the role includes a plurality of roles, and the notification includes a plurality of notifications leading to the goal state.

22. A computer-readable storage medium having computer-executable instructions stored thereon which, when executed by a computing system, perform a method of processing complex events in a dynamic system, the method comprising:
receiving a plurality of data streams from a dynamic system at a complex event processing system;
defining measurements based on data in the data streams, and observations associated with the measurements;
detecting an occurrence of an event based on interpretation of the observations;
upon occurrence of the event, determining a current state of a state model;
if the current state is not a goal state, determining a next state to which the state model should transition;
based on the current state and the next state, determining an action to be taken, a role associated with the action, and a notification based on the role and the action; and
sending the notification and action to an entity assigned the role.

23. The computer-readable storage medium of claim 22, further comprising waiting a predetermined time after sending the notification for the action to be performed, and, if the action is not performed within the predetermined time, escalating the event.
